(19) United States
(12) Patent Application Publication
(10) Pub. No.: US 2010/0009101 A1
(43) Pub. Date: Jan. 14, 2010

(54) PRINT SHEET

(75) Inventors: Tsuneyuki Sasaki, Fukushima-ken (JP); Hirotoshi Terao, Fukushima-ken (JP)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: ALPS ELECTRIC CO., LTD, Tokyo (JP)

(21) Appl. No.: 12/497,014

(22) Filed: Jul. 2, 2009

(30) Foreign Application Priority Data
Jul. 11, 2008 (JP) 2008-181152

(51) Int. Cl. B41M 5/40

(52) U.S. Cl. 428/32.39

(57) ABSTRACT

A print sheet which is transported by transporting means and inserted between a thermal head and a platen which are disposed to oppose to each other in a printing unit of a printer, which is to be used for printing, includes: a chamfered portion to decrease the sheet thickness of at least one surface of the front and rear surfaces and which is formed at the end portion in the supply direction of the printing unit.

### CROSS REFERENCE TO RELATED APPLICATION

The present invention contains subject matter related to and claims priority to Japanese Patent Application No. 2008-181152 filed in the Japanese Patent Office on Jul. 11, 2008, the entire contents of which are incorporated herein by reference.

### BACKGROUND OF THE DISCLOSURE

1. Technical Field

The present disclosure relates to a print sheet suitable for printing a desired text, an image, or the like on the entire sheet without a margin at each side.

2. Related Art

Recently, with the demand for high resolution, multi-tone printing, fast printing, and the like, a thermal printer having a thermal head configured by arranging plural heating elements in a row as heating resistors on a substrate, has been used as a type of printer for color printing.

In the thermal head of the aforementioned thermal printer, the substrate is attached to a head mounting board to be mounted on the printer main body. When printing is performed, the head mounting board is rotated to allow the heating element of the thermal head to come in contact with the platen in the shape of a roller mounted on the printer main body, with a print sheet interposed therebetween. Examples of the print sheet may include a direct sheet in the case of heat-sensitive paper printing, an ink film having an ink layer formed at a side of a sheet such as a transparent PETP film and a PEN film in the case of thermal transfer printing and dye sublimation printing, normal sheets, and OHP films.

When printing is performed, under the control of a controller, a print sheet is transported and pinched between the thermal head and the platen, plural heating elements are selectively heated on the basis of the printing information while transporting the print sheet and winding the ink film, and inks on the ink layer are partially melted in the case of a thermal transfer printer and partially sublimated in the case of a dye sublimation printer, to be transferred to the print sheet by heating the ink film, thereby printing the desired text and/or image(s) (see, for example, JP-A-2006-88622).

However, recently, in the case of printing pictures taken by a digital camera, printing over the entire surface of a print sheet cut to predetermined dimensions in advance, that is, so-called “printing without margins” is increasingly necessary.

When printing without margins is performed, a state where a thermal head and a platen are in contact with each other, or a state where the end of a print sheet PS is inserted into a gap which is smaller than the thickness of the print sheet PS being used and the thermal head and the platen are almost in contact with each other as illustrated in FIG. 6, is necessary.

In addition, as described above, when the end of the print sheet is to be inserted where the thermal head 1 and the platen 2 are in contact with each other or almost in contact with each other, the insertion of the print sheet PS is first interrupted, and buckling of the print sheet PS occurs. As described above, when the insertion of the print sheet PS between the thermal head 1 and the platen 2 is first rejected, a change in speed during sheet transportation, that is, so-called “jitter” occurs, and the change in speed results in horizontal lines being printed on the printed output. In addition, since the print sheet PS is curved by buckling, a paper jam occurs, and the print sheet itself is damaged. As a result, there is a problem in that a good quality printed output cannot be obtained.

These and other drawbacks exist.

### SUMMARY OF THE DISCLOSURE

To obtain a good quality printed output, it is desirable that a print sheet be provided which can be smoothly inserted between a thermal head and a platen which are in contact with or almost in contact with each other.

According to one embodiment, there is provided a print sheet which is transported by transporting means and inserted between a thermal head and a platen which are disposed to oppose each other in a printing unit of a printer, which is to be used for printing. In such an embodiment, the print sheet may include: a chamfered portion to decrease the sheet thickness of at least one surface of the front and rear surfaces and which is formed at the end portion in the supply direction of the printing unit.

Specifically, the chamfered portion has a dimension y in a thickness direction equal to or less than t/2 mm in the case where the sheet thickness is t mm and a dimension x in a longitudinal direction in the range of approximately 0.05 to 0.5 mm from the end in the feeding direction, and is tapered such that an inclination angle θ of a cut-off imaginary plane is equal to or less than approximately 30°.

In addition, the one surface where the chamfered portion is formed is on a side where the friction with the thermal head or the platen is higher than the other side.

In the print sheet according to various embodiments, since the chamfered portion is formed at the end in the supply direction of the printing unit, the insertion force is reduced when the print sheet is inserted between the thermal head and the platen which are in contact with or almost in contact with each other, and the print sheet can be smoothly inserted. Therefore, the generation of horizontal lines caused by a change in speed during sheet transportation can be prevented, so that it is possible to obtain a good quality printed output. In addition, there is no possibility that the print sheet will be damaged by buckling during insertion, and paper jams will rarely occur.

### BRIEF DESCRIPTION OF THE DRAWINGS

FIG. 1 is a diagram schematically illustrating a structure of a main part of a print sheet according to an embodiment of the disclosure.

FIG. 2 is a diagram schematically illustrating a structure of a print sheet according to the embodiment of the disclosure.

FIG. 3 is a diagram schematically illustrating a structure of the print sheet according to the embodiment of the disclosure.

FIG. 4 is a graph showing an insertion force exerted between a thermal head and a platen, in relation to an inclination angle of a chamfered portion of the print sheet, according to an embodiment of the disclosure.

FIG. 5 is a diagram schematically illustrating an insertion state of the print sheet inserted between the thermal head and the platen, according to an embodiment of the disclosure.

FIG. 6 is a diagram schematically illustrating an insertion state of a print sheet inserted between a thermal head and a platen according to a related art.

### DESCRIPTION OF EXEMPLARY EMBODIMENTS

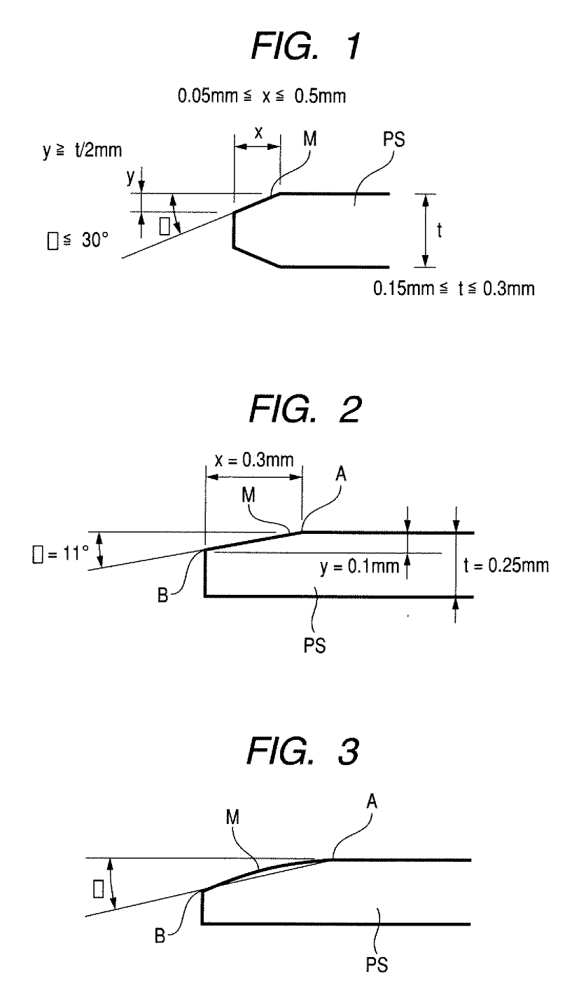

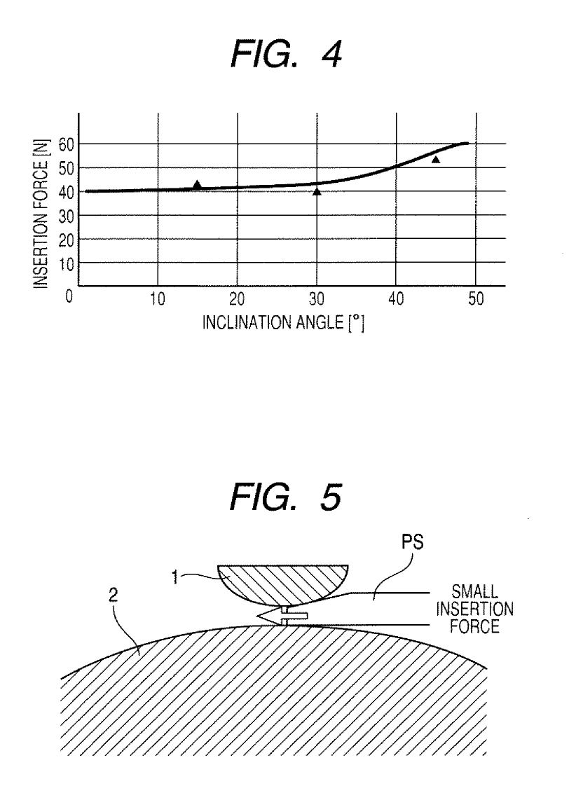

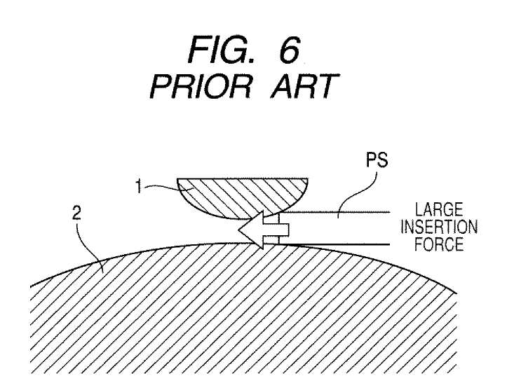

The following description is intended to convey a thorough understanding of the embodiments described by providing a number of specific embodiments and details involving print sheets. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs. Hereinafter, a print sheet according to an exemplary embodiment will be described with reference to FIGS. 1 to 5. FIG. 1 is a diagram schematically illustrating a structure of a main part of a print sheet according to an exemplary embodiment. FIG. 2 is a diagram schematically illustrating a structure of a print sheet according to an exemplary embodiment. FIG. 3 is a diagram schematically illustrating another exemplary structure. FIG. 4 is a graph showing an insertion force exerted between a thermal head and a platen, in relation to an inclination angle of a chamfered portion of the print sheet, according to an exemplary embodiment. FIG. 5 is a diagram schematically illustrating an insertion state of the print sheet inserted between the thermal head and the platen, according to the embodiment of the invention.

A print sheet PS according to the embodiment may be put on a transportation path in a printer and transported by driving a pair of transportation rollers which may be rotated while pinching the print sheet PS therebetween. In a printing unit which may print on the print sheet PS on the transportation path, a thermal head 1 may be disposed to oppose a platen 2 which may be of a roller type to be rotatably mounted below the transportation path, with a gap smaller than the thickness of the print sheet PS used for printing. During printing, the thermal head 1 may come into pressing contact with the platen 2 while the print sheet PS is interposed therebetween.

In addition, a chamfered portion M for gradually decreasing the sheet thickness may be formed at the end portion in the supply direction of one surface of the front and rear surfaces of the print sheet PS in the printing unit. In this embodiment, the chamfered portion M may be formed at the end in the supply direction of a surface of the print sheet PS, which will be a surface contacting the thermal head 1. As illustrated in FIG. 1, the chamfered portion M may have a dimension y in a thickness direction of the print sheet PS equal to or less than t/2 mm in the case where the sheet thickness t may be in the range of approximately 0.15 to 0.3 mm and a dimension x in a longitudinal direction in the range of approximately 0.05 to 0.5 mm from the end in the feeding direction, and may be tapered such that an inclination angle θ of a cut-off imaginary plane connecting a side A of the front and rear surfaces to a side B of the end surface is equal to or less than approximately 30°. Specifically, as illustrated in FIG. 2, when the thickness t of the print sheet PS is 0.25 mm, the dimension y of the chamfered portion M in the thickness direction may be approximately 0.1 mm, the dimension x in the longitudinal direction may be approximately 0.3 mm from the end in the supply direction, and the chamfered portion M may be tapered such that an inclination angle θ of the cut-off imaginary plane may be approximately 11°.

In various embodiments, it may be that the friction between the thermal head 1 and the print sheet PS is higher than the friction between the rotatable platen 2 and the print sheet PS. Therefore, the chamfered portion M may be formed at the surface of the print sheet PS to allow the side of the print sheet PS with higher friction to be easily inserted between the thermal head 1 and the platen 2.

In addition, the chamfered portion M formed by gradually decreasing the sheet thickness does not need to be flat as in various embodiments, and may, for example, have a curved surface as illustrated in FIG. 3. In this case, the inclination angle θ of the cut-off imaginary plane may be equal to or less than 30°. A reason why the inclination angle θ of the cut-off imaginary plane is equal to or less than approximately 30° is that the energy (hereinafter, referred to as the insertion force) for inserting the print sheet PS between the thermal head 1 and the platen 2 as illustrated in FIG. 4 may be reduced, that is, insertion may become easy in the case where the inclination angle of the chamfered portion M is equal to or less than approximately 30°. In addition, this experiment was performed on three samples to measure insertion force [N] by setting the inclination angle θ to 15°, 30°, and 45° and using the dimensions set in FIG. 2. In addition, the dimension x of the chamfered portion M in the longitudinal direction is smaller than 0.5 mm from the end in the supply direction, since, in the case where the dimension x is equal to or greater than 0.5 mm, an area where a desired text or an image cannot be properly printed is clearly seen to form at the end portion of the print sheet PS. This results in the deterioration of the printed output. In addition, the dimension x of the chamfered portion M in the longitudinal direction is greater than 0.05 mm from the end in the supply direction, since, in the case where the dimension x is equal to or smaller than 0.05 mm, the object of decreasing the insertion force during insertion cannot be achieved.

As described above, when the print sheet PS having the chamfered portion M formed at the end in the supply direction of the printing unit is inserted between the thermal head 1 and the platen 2, which are in contact with or almost in contact with each other as illustrated in FIG. 5, the insertion force may be reduced and the print sheet PS can be smoothly inserted. Therefore, the generation of horizontal lines caused by a change in speed during sheet transportation can be prevented, so that it is possible to obtain a good quality printed output. In addition, there is no possibility that the print sheet PS will be damaged by buckling during insertion, and paper jams will rarely occur.

The invention is not limited to the above-mentioned embodiment, and various modifications can be made as needed.

For example, in this embodiment, the chamfered portion is formed only at the one surface of the print sheet where higher friction is exerted during transportation. However, the chamfered portion may also be formed at both surfaces. In addition, in this case, different dimensions may be given to the chamfered portions at both surfaces.

In addition, in many cases, it is not determined which one, among the four sides of a single-cut print sheet to be supplied to a printer, is the end in the supply direction. For example, in the case where rectangular print sheets PS having A sizes, B sizes, whole sizes, and the like do not have front and rear surfaces, the chamfered portion may be formed on at least a long side and a short side.

It should be understood by those skilled in the art that various modifications, combinations, sub-combinations and alterations may occur depending on design requirements and other factors insofar as they are within the scope of the appended claims of the equivalents thereof.

Accordingly, the embodiments of the present inventions are not to be limited in scope by the specific embodiments described herein. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. A print sheet which is transported by transporting means and inserted between a thermal head and a platen which are disposed to oppose to each other in a printing unit of a printers which is to be used for printing, the print sheet comprising:
a chamfered portion to decrease the sheet thickness of at least one surface of the front and rear surfaces and which is formed at the end portion in the supply direction of the printing unit.

2. The print sheet according to claim 1, wherein the chamfered portion has a dimension y in a thickness direction equal to or less than t/2 mm in the case where the sheet thickness t is in the range of 0.15 to 0.3 mm and a dimension x in a longitudinal direction in the range of 0.05 to 0.5 mm from the end in the feeding direction, and is tapered such that an inclination angle θ of a cut-off imaginary line is equal to or less than 30°.

3. The print sheet according to claim 1, wherein the one surface where the chamfered portion is formed is on a side where the friction with the thermal head or the platen is higher than the other side.

4. The print sheet according to claim 2, wherein the one surface where the chamfered portion is formed is on a side where the friction with the thermal head or the platen is higher than the other side.
